(19) United States
(12) Patent Application Publication
(10) Pub. No.: US 2014/0041356 A1
(43) Pub. Date: Feb. 13, 2014

(54) Multifunctional Rake

(71) Applicant: Paul Barden Alfonsi, Guiford, CT (US)

(72) Inventor: Paul Barden Alfonsi, Guiford, CT (US)

(21) Appl. No.: 13/572,990

(22) Filed: Aug. 13, 2012

(51) Int. Cl. A01D 7/00

(52) U.S. Cl. 56/400.2

(57) ABSTRACT

A multifunctional rake of the lawn rake design that allows the rake operator to easily move leaves and leave piles with a simple conversion. The multifunctional rake offers the operator the options of either pulling the leaves towards the operator in short strokes like a traditional prior art lawn rake (pull mode), or pushing the leaves in short forward motion strokes (push mode), and further by plowing them forward in a continuous smooth motion (plow mode). This novel invention allows the operator to use only one simple device to perform all of the pull, push, or plow operations needed to move leaves rather than a multitude of devices including but not limited to; a rake, leaf blowers, lawn bags, tarps, carts, or wheelbarrows.

### BACKGROUND OF THE INVENTION

1. Field of the Invention

Embodiments of the invention described herein pertain to raking devices for the moving and gathering of lawn debris. More particularly, but not by way of limitation, a rake that can perform the pull functions of a standard lawn rake and also be utilized to push or plow a pile of leaves with an easy adjustment.

2. Description of Related Art

Every fall, people are faced with the task of having to cleanup all the fallen leaves that collect on their yard. A variety of options are available to the homeowner or contractor to perform this often tedious and time consuming task. For the collection of leaves into a pile, the individual may blow the leaves with a leaf blower or rake them with a lawn rake. Rakes having a fan shaped head and an elongated handle are generally well known in the art of leaf moving tools. The conventional rake is generally designed to move leaves by pulling the leaves toward the user in a pulling motion. Most commercially available rakes are designed for this standard pulling motion; however, this pulling motion is not always effective or efficient for moving wet and heavy leaves, or a pile of leaves. One of the most common methods of leaf gathering is to rake the leaves into a central pile for further transport. The rake operator often finds him/herself in a predicament of having to find another method to move the large pile of leaves since it is no longer feasible raking the leaf pile using the standard pull method or the leaf blower lacks the power necessary to move the pile forward. The rake operators only option is to either exert a tremendous amount of effort and/or compromise the structural integrity of the rake to continue raking or blowing the pile towards the final destination of the edge of woods or street curb. The operator now has to looks for an alternate method to move the pile of leaves. The most common methods of moving leaf piles include bagging, placing the pile on a sheet or tarp and then carrying the pile to the desired destination, or utilizing various carts or wheelbarrows. Leaf blowers are not efficient at moving large piles of leaves and a great amount of effort is required to either bag the leaves or load the pile onto a sheet/tarp and then carry or drag the complete pile to the final destination. Carts and wheelbarrows hold only a limited amount of leaves and often create more of a mess by spilling or tipping over during transport. Accordingly, there has been a need for a multifunctional rake that would allow the user to rake the wet and/or heavy leaves into a pile using the standard pull method and then to push and or plow the pile of leaves towards the final destination.

There is a plethora of leaf movement devices and configurations that are well known in the prior art. Many of these devices do a fine job performing their intended function; however, none of the following are capable of doing all the functions of the present invention. With the present invention, the operator can rake leaves into a pile using the traditional pull mode of operation, and then transform the rake into a push or plow mode for transporting the leaves by either pushing or plowing them to the final destination. The present invention has a first and second position and three modes of operation (pull, push, and plow). While in the first position, the rake head is in the conventional position or a straight line with the handle and is best for the pull mode of operation. In the second position, the rake head is angled in any position between the straight line to at least 90 degrees. While in the second position, the rake can be utilized for either the push or the pull mode of operation. All of the above mentioned capabilities can be performed ergonomically with a single multifunctional apparatus.

Leaf transport designs include U.S. Pat. No. 5,971,410 to Nichols discloses a leaf transport caddy. U.S. Pat. No. 4,503,661 to Potter discloses a leaf and lawn debris lift and bagger apparatus. U.S. Pat. No. 4,629,203 to Ballard discloses a Yard caddy and U.S. Pat. No. 4,957,306 to Greenberg discloses a leaf wagon. Leaf bagging and collecting designs are numerous and include U.S. Pat. No. 3,744,081 to Miller which discloses a plastic leaf collection bag. U.S. Pat. No. 5,593,117 to Alexander discloses a lawn and garden debris collecting apparatus. U.S. Pat. No. 4,378,670 to Check and Goodby discloses a hand scoop for grass and leaves pickup and collection. U.S. Pat. No. 4,991,386 to Dirksen discloses a combination leaf caddy and pickup tool. Leaf push and/or plow devices include U.S. Pat. No. 4,048,735 to Brunty discloses a wheeled pusher device. U.S. Pat. No. 4,987,731 to Cianciulli et al. discloses a leaf pusher attachment for lawn mowers. U.S. Pat. No. 6,161,851 to Garner, Jr. discloses a leaf mover system and cart combination. U.S. Pat. No. 4,888,942 to Monaco discloses a device for pushing leaves with a pusher blade. U.S. Pat. No. 2,329,708 to Fetterman is a push only rake on rollers designed to rake, collect, and plow leaves and debris. The whole assembly is somewhat complex and ungainly, and its size would create a storage dilemma. U.S. Pat. No. 4,970,853 to Greene and U.S. Pat. No. 6,918,240 B2 to Hurt are both push only rakes and are not designed for pulling or plowing. U.S. Pat. No. 2,797,544 to Fite, U.S. Pat. No. 5,303,536 to Tolliver, and U.S. Pat. No. 5,564,267 to Bricker and Greenfield are combination pull rake and leaf pickup devises and are limited by their ability to move substantial amounts of leaves or debris. All of the above mentioned devices are capable of performing only one of the pull, push, or plow qualities provided by the current invention.

Current multifunctional rake designs vary widely. U.S. Pat. No. 5,522,629 to Loo is a reversible rake and shovel that is designed to be pulled or pushed but is limited by the size of the scoop and ability to properly rake a lawn. U.S. Pat. No. 5,142,855 to Guidarelli discloses a leaf rake designed to be capable of pulling and pushing by simply rotating the rake head. This rake is very bulky due to the duplication of the heads and the ability to plow sufficiently is questionable. U.S. Pat. No. US2007/0289283 A1 to Hanas provides pushing capabilities by rotating the rake head to push small amounts of leaves/debris with the help of rollers. This rake is not designed for plowing or moving substantial amounts of leaves/debris and does not have the capability to pivot into an ergonomically friendly position for the pushing or plowing of leaves. U.S. Pat. No. 5,069,026 to Johnson is a pull and push rake that is limited in its capacity to plow by its small basket size and its poor plowing angle. This rake also lacks any adjustment for the user's height and is therefore ergonomically deficient. Several prior art rakes with pulling and pushing abilities are more suitable for the tiling of gardens such as U.S. Pat. No. Des. 306,682 to Thompson, U.S. Pat. No. 4,970,853 to Green, III, U.S. Pat. No. 4,901,801 to Popivalo, U.S. Pat. No. 4,644,740 to Lee, and U.S. Pat. No. 1,239,735 to Smith and Lamb.

The inventor of the proposed multifunctional rake experimented with several conventional prior art lawn rakes that are readily available in local hardware stores, to see how they would handle the tough task of plowing a pile of leaves. To accomplish this, the inventor flipped several prior art lawn rakes over and used the back side to push and plow the leaf piles. In all cases, the rakes broke either at the top portion of the rake head or at the handle and were not ergonomically comfortable for this task. All of the prior art designs mentioned above are not adequately designed, or have other disadvantages or limitations that make them less than optimally suitable to perform all the combined functions and abilities of the present invention. Also, none of the prior art rakes provides a means for angling the rake head relative to the direction of movement of the rake head, so that it can truly act as a plow.

### SUMMARY OF THE INVENTION

The present invention sets forth an improved raking device embodying advantageous alternatives to prior art raking devices. The multifunctional rake is of the lawn rake design and allows the rake operator to easily move a pile of leaves by either pulling the leaves towards the operator in short strokes like a traditional prior art lawn rake (pull mode), or by pushing the leaves in short forward motion strokes (push mode), and further by plowing them with a continuous smooth forward motion (plow mode). While in either of the push or plow modes of operation, the rake operator is capable of moving heavy piles of leaves across the ground surface more efficiently and with less effort and in an ergonomically efficient manner than any prior art lawn rake. The multifunctional rake allows the operator to use one simple device to perform all of the pull, push or plow operations needed to move leaves instead of a multitude of devices including but not limited to; a rake, leaf blowers, lawn bags, tarps, carts, or wheelbarrows.

As a pull rake, with the rake in the first position, the operator can use short jerking motions to pull the leaves towards the operator. As a push rake, with the rake in the second position, the operator can use short jerking forward motions to push the pile of leaves forward, or while in the same second position, as a plow rake, to plow the leaves in one continuous forward moving motion while walking forward at the same time. The present invention has many of the parts and features of a standard lawn rake such as an elongated handle and a rake head with a support frame and tines and also includes several novel embodiments that are unique to this invention.

The present embodiment improves on the standard lawn rake design, function, and use with the novel embodiment now described. In addition to the above mentioned standard rake components, the present invention adds components such as a manually moveable means, a pivot means, a locking device, and structural members that allow it to function easily and properly as a multifunctional rake. In order to be adjustable and functional in the three modes of operation, the present invention utilizes all of the rake components in a unique and efficient manner.

To convert the rake head from the standard pull mode or first position, to the push or plow modes or second position, the rake head must be manually adjusted from a straight standard type rake position to a rake head position pivoted with an angle of at least 90 degrees from the straight position. To accomplish this conversion, the operator first unlocks a sleeve, located on the elongated handle, from its current first position by pulling up on a locking pin knob, and then moves the sleeve in an upward manner along the handle that in turn moves a V shaped brace rod that is pivotally attached to the rake head and the sleeve. This upward movement on the sleeve causes the pivot means to rotate which in turn pulls the rake head towards the operator until the desired angle of the rake head is achieved for the push/plow operation. The rake is then locked into the desired push/plow position or second position by releasing the locking pin so that it enters the most proximal locking port. With the rake locked into the push/plow position, the operator can then flip the rake over and push or plow the leaves. During either the push or plow mode of operation and as the leaves are pushed against the back side or face of the rake head; the brace rod, and other structural features, provide the strength needed to successfully push or plow a heavy pile of leaves the desired distance. The rake also offers a variety of rake head positions; allowing the operator to fine tune the rake head position by choosing from a plurality of locking ports. This flexibility allows for individual variations in user height or arm length, thereby creating more comfortable and ergonomic positions for the operator.

To better understand the invention, its operating advantages and specific objects attained by its users, refer to the accompanying drawings and descriptive matter in which the invention is illustrated. The various features of novelty which characterize the invention are pointed out with particularity in the claims annexed to section and form a part of this invention. It will be understood that the disclosed embodiments generally described below and illustrated in the attached drawings are merely exemplary of the present invention, which may be embodied in various forms. Therefore, specific details disclosed herein are not to be interpreted as limiting, but rather as representative and provide a basis for variously employing the present invention in any appropriate manner understood by one of ordinary skill in the art.

### BRIEF DESCRIPTION OF THE DRAWINGS

The figures which accompany the written portion of this specification illustrate embodiments and method(s) of use for the present invention as constructed and operative according to the teachings of the present invention.

FIG. 1 is a front view of one preferred embodiment of the multifunctional rake.

FIG. 2 is a cross section of FIG. 1 along line 2-2 enlarged to show details of 40a and 40b with locking pin 20 in the locked position.

FIG. 3 is FIG. 2 with the locking pin 20 in the open position.

FIG. 4 is a back view of the rake of FIG. 1.

FIG. 5 is the side view of the rake of FIG. 1.

FIG. 6 is a side view of the rake of FIG. 1 showing the rake in the pull mode (first position).

FIG. 7 is a side view of the rake of FIG. 1 showing the rake in the push or plow mode(s) (second position).

FIG. 8 is a perspective view of the rake in FIG. 1 in the pull mode (first position) of operation.

FIG. 9 is a perspective view of the rake in FIG. 1 in the push or plow mode(s) (second position).

FIG. 10 is a fragmentary detail view similar to FIG. 2, but showing a second embodiment of the present invention.

### DRAWINGS

### Reference Numerals

10 Multifunctional Rake
12 Elongated Handle
12a Elongated Handle upper end
12b Elongated Handle lower end
12c Elongated Handle externally treaded lower end
12d Elongated Handle rectangular section for second embodiment
14 Sleeve
14b Rectangular Shaped Sleeve for second embodiment
16 Locking Knob
18 Locking Ports
20 Locking Pin
22 Brace Rod
24 Upper Pivot Collar with Socket
26 Lower Pivot Collar
28 Pivot Washers (4)
30 Pivot Pin
32 Support Frame
34 Lower Brackets with Bearing Sockets (2)
36 Stiffening Cross Brace
38 Rake Tines
39 Rake Tine Tips
40a Manually Movable Means
40b Locking Mechanism
42 Pivot Means
44 Rake Head
46 Upper Pivot Collar with Socket
50 Compression Spring
52 Retainer Clip

### DESCRIPTION OF THE ILLUSTRATED EMBODIMENTS

In the following exemplary description, numerous specific details are set forth in order to provide a more thorough understanding of embodiments of this invention. It will be understood that the disclosed embodiments generally described below and illustrated in the attached drawings are merely exemplary of the present invention, which may be embodied in various forms. Therefore, specific details disclosed herein are not to be interpreted as limiting, but rather as representative and provide a basis for employing the present invention in any appropriate manner understood by one of ordinary skill in the art. Readers should note that although examples of the invention are set forth herein, the claims, and the full scope of any equivalents are what define the metes and bounds of the invention.

The present invention sets forth an improved raking device of the lawn rake design and allows the operator the option of using the multifunctional rake in a standard pulling motion or with a simple adjustment, an additional use as a push or plow rake. The present embodiment improves on the standard lawn rake and previous leaf collection and movement devices with the novel embodiment now described.

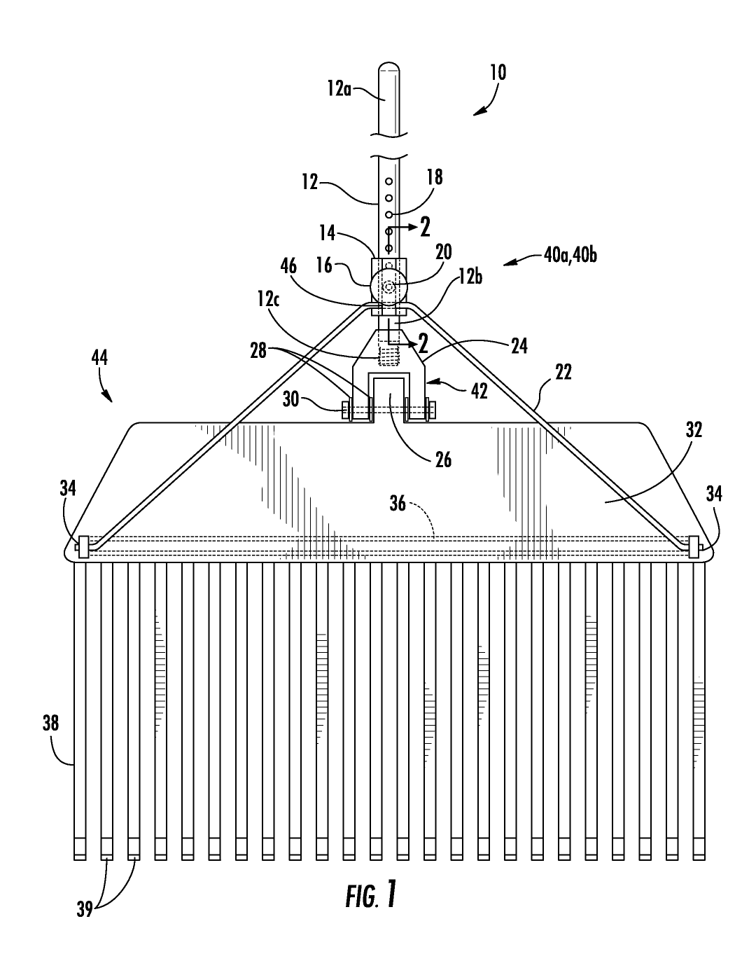

Referring now to the drawings, the multifunctional rake, herein referred to as rake 10, and is shown in FIG. 1. FIG. 1 shows a front view of an embodiment of the invention in the pull mode or first position. Rake 10 includes similar parts, features, dimensions, and shape of a standard lawn rake including an elongated handle 12 and a rake head 44 with support frame 32 and rake tines 38. Rake 10 is designed with embodiments that make it uniquely different from a standard lawn rake. In the particular illustrated embodiment, rake 10 also includes a pivot means 42, manually moveable means 40a, locking mechanism 40b, and other components, that allow the rake to be easily converted from the standard pull lawn rake to a push & plow rake.

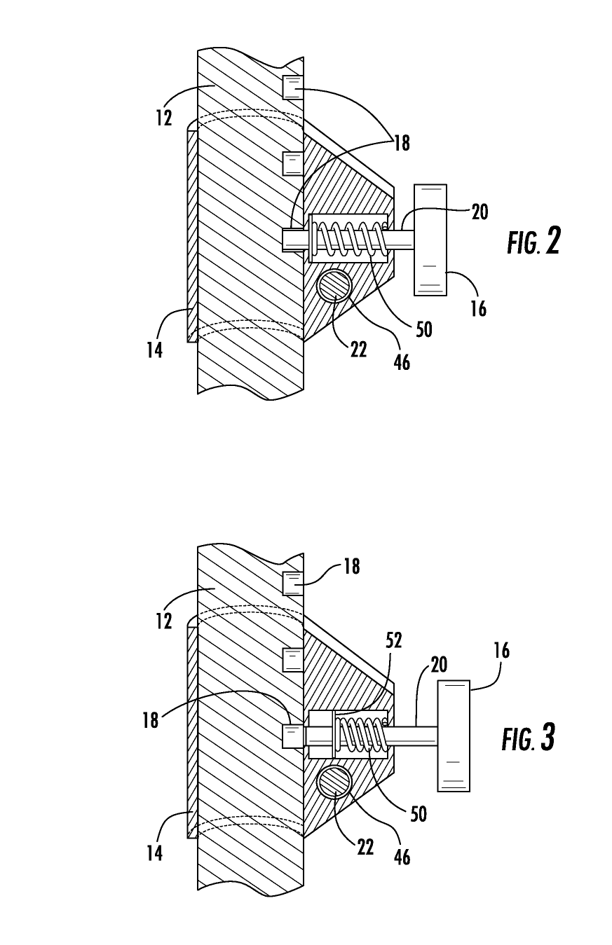

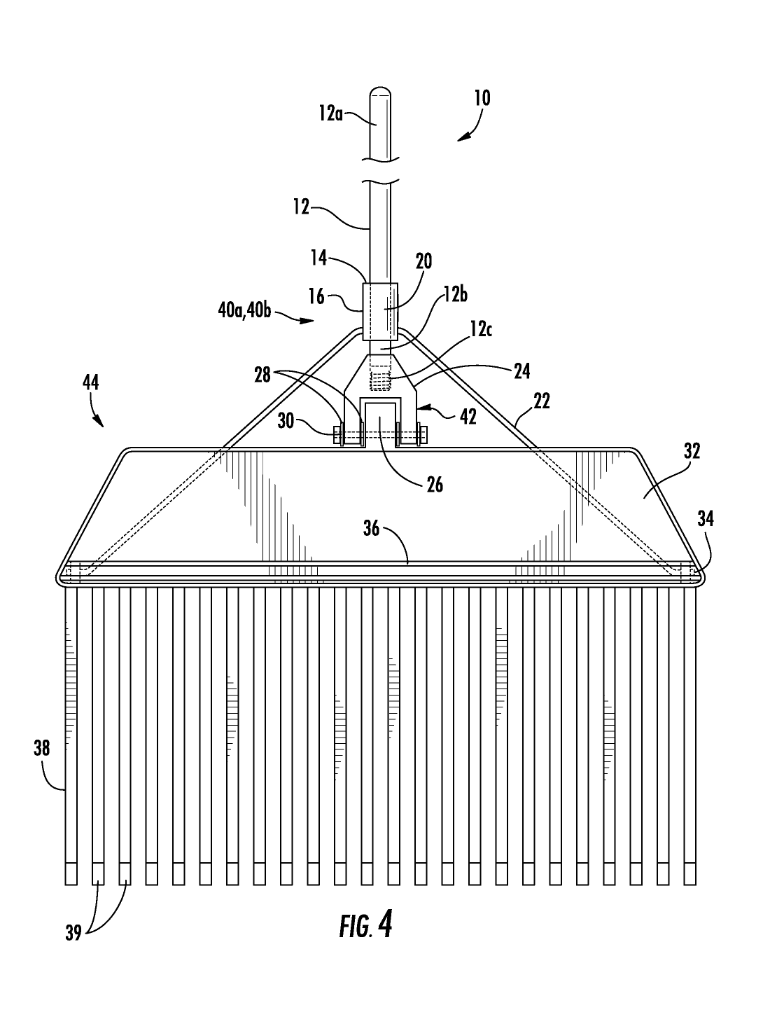

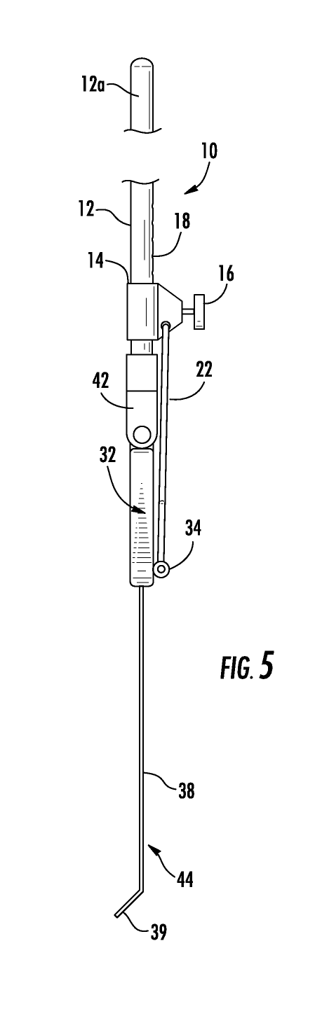

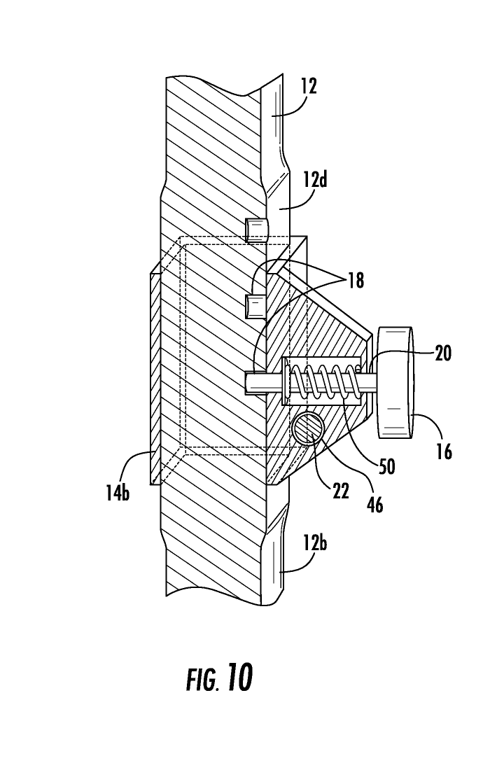

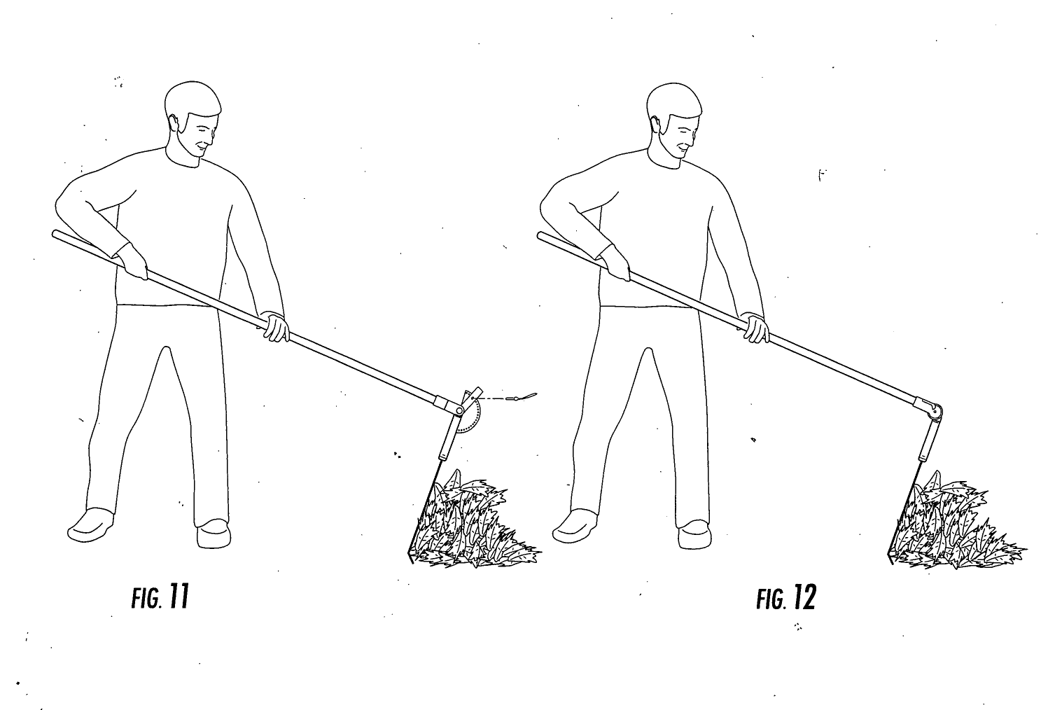

In the illustrated embodiment, rake 10 comprises an elongated handle 12 having a longitudinal axis, an upper end 12a (second end), a lower end 12b (first end), and a generally uniform round shaped cross section along the majority of its length. The upper end 12a is for the grasping and handling of rake handle 12 while the lower end is for attachment to another rake member such as the pivot means 42 or rake head 44. The elongated handle 12 has a plurality of lock ports 18 located longitudinally and evenly spaced on the top side of handle 12 for receiving the locking pin 20 per FIGS. 2 and 3. The handle 12 is preferably fabricated from relatively light-weight, strong and durable material. The handle 12 may be constructed of, for example, fiberglass, wood, metal, plastics, polymers, or combinations thereof. The handle 12 should be of sufficient strength to handle the forces applied when in all three modes of operation. It will be appreciated that the handle 12 construction may be provided in various configurations without departing from the scope of the present invention. Additionally, the illustrated size, shape, configuration, and arrangement of the handle 12 can be varied as would occur to one of ordinary skill in the art. In a particular embodiment shown in FIG. 10, the elongated handle 12 is rectangular in shape (shown as 12d) at the lower end to accommodate the travel of the rectangular sleeve 14d. As shown in FIG. 8 (pull mode), and FIG. 9 (push and plow mode); the handle 12 is typically gripped at the upper end 12a during all three modes of operation. In other embodiments not shown, the upper handle 12a may be made of or partially encapsulated within a separate material, such as a pliable foam rubber, or shaped differently than shown in FIG. 1 to enhance comfort and grip. The drawing of FIG. 1 shows an externally treaded lower end 12b connected to the internally treaded socket end of the upper pivot collar with socket 24 configured so as to be mateable with a conventional rake head type socket. However, in another embodiments (not shown), the handle 12 may be fixedly attached to the upper pivot collar with socket 24, or to rake head 44, or they may be one composite member.

As shown in FIG. 1, rake 10 of this embodiment also includes rake head 44, which is preferably a single unitary structure having a face on one side for engaging leaves, and consisting of lower pivot collar 26, support frame 32, a plurality of raking tines 38 extending downward from the support frame 32 and arranged along a first plane with rake head 44. In the illustrated embodiment, rake head 44 has two lower brackets with bearing sockets 34 located on the rake head 44 front side and at each end of a stiffening cross brace 36 to accept the free ends of brace rod 22. The stiffening cross brace 36 provides rake head 44 with the additional structural reinforcement that's required to plow a pile of wet leaves. Stiffening cross brace 36 is shown in FIG. 1 as a composite of rake head 44, however; in alternate embodiments, it may include stiffeners or reinforcements that are attached and still other embodiments may include no stiffener at all, but may have an overall increase in material strength or size. Rake head 44 includes a plurality of rake tines 38 extending down from the support frame 32 at least partially in a plane defined by rake head 44 and are preferably uniform in size. Rake tines 38 are also shown as a composite with the support frame 32 in FIG. 1, however; in alternate embodiments, the tines 38 could be composed of a variety of possible appropriate materials, such as metal, or they may be fixedly attached to the support frame 32. The rake tine tips 39 are located at the distal end of the rake tines 38 and in the illustrated embodiment are shown angularly disposed so that during operation the rake tine tips 39 are at an optimum angle from the ground surface, however; alternate embodiments may not be angularly disposed. The rake tine tips 39 are used to make contact with the ground surface during the three modes of operation. In other embodiments, the rake tine tips 39 may have alternate shapes such as V shaped to prevent leaf clogging as shown in some current prior art rakes.

Rake head 44 may be constructed of, for example, fiberglass, wood, metal, plastics, polymers, or other sufficiently strong material or combinations thereof. Alternate embodiments of the rake head 44 (not shown) may include one or more methods to increase the strength of the rake head 44, but not limited to, added material thickness, or additional stiffening brace members. In certain embodiments, the flexibility of rake head 44 and tines 38 may be relatively stiff and sturdier, when compared to the somewhat flimsy tines of prior art lawn rakes, in order to promote quick and efficient moving and gathering of deep and/or wet leaves especially during the second position or push or plow mode(s) of operation. The preferred shape for the rake head 44 may be more of a rectangular shape (as shown in FIG. 1) than the typical triangular or fan shaped rake head so that the additional surface area provided by a rectangular shaped rake head can be utilized to push or plow a larger quantity of leaves than the typical rake head, however; in certain embodiments not shown, the shape of rake head 44 could be the typical triangular or fan shape. As shown in FIG. 1, the preferred bottom shape of rake head 44 may be somewhat flatter when compared to any prior art or conventional lawn rake designs so that during the push or plow mode(s) (second position), the flatter surface helps to prevents leaves from passing beneath the rake head surface, however; other embodiments may have the standard curved shape of prior art rakes. It will be appreciated that the construction of rake head 44, and all the components of rake head 44, may be provided in various configurations, materials, sizes, shapes, and arrangements without departing from the scope of the present invention and as would occur to one of ordinary skill in the art.

Rake 10 comprises a brace rod 22 to provide the best distribution of the forces from the rake head 44 to the manually moveable means 40a and ultimately to rake handle 12. In the preferred embodiment shown in FIG. 1, brace rod 22 is V shaped with the apex facing upwards and attached to sleeve 14. Brace rod 22 is pivotally connected to support frame 32 at the two lower bracket with bearing sockets 34 and to the sleeve 14 at upper bracket and bearing socket 46. As shown in FIG. 1, the apex of brace rod 22 is formed so that the transverse segment can be rotatively retained onto the sleeve 14 with upper bracket and bearing socket 46. The brace rod 22 has two lower shaft segments with free ends outwardly bent and adapted for positioning in rotative relationship within the two lower bracket bearing sockets 34. The brace rod 22, when in the locked position, is designed to provide a structural connection between the rake handle 10 and the rake head 44 and also provides the additional structural support that rake head 44 requires when using rake 10 in any of the three modes (pull, push, and plow) of operation. The brace rod 22 is preferably made of metal and of adequate strength to performing the desired tasks. In other embodiments, not shown, the brace rod 22 could be more of a U shape. Yet in other embodiments, the brace system could be a single rod structure, several independent rod type structures, or a substantially flat planar V or U shaped structure, or they could vary as would occur to one of ordinary skill in the art. The two lower bracket with bearing sockets 34 and the upper bracket and bearing socket 46 in the illustrated embodiment are shown molded as an integral unit with support frame 32 and sleeve 14 respectively; however, in other embodiments not shown, they may be fixedly attached with screws, nails, rivets or the like. It is preferable that the two lower bracket bearing sockets 34 and stiffening cross brace 36 be located on the support frame 32 in a position slightly lower to the longitudinal center of gravity of the rake head 44 thereby providing less mechanical stress on the rake head during the push or plow mode(s) (second position).

Rake 10 includes a manually movable means 40a by which the rake operator can manually adjust the rake head 44 into either a pull (first position) or the push or plow mode(s) (second position) of operation. When operated with the brace rod 22, the manually moveable means 40a provides the operator with the ability to move the rake head 44 into a plurality of positions. In the preferred embodiment, the manually moveable means 40a includes a sleeve 14 located on the handle 12. Sleeve 14, as illustrated in FIG. 1, and in more detail in FIGS. 2 and 3, is shown in this embodiment as being cylindrical in shape and has an inner diameter just slightly greater than the outer diameter of the elongated handle 12 so that it can easily and manually slide longitudinally up and down the handle 12. The upper bracket and bearing socket 46, located on the sleeve 14, rotatively retains the brace rod 22 at its apex. The brace rod 22 connects the sleeve 14 with the rake head 44, and it moves the rake head 44 into its various positions with a corresponding up and down manual movement of the sleeve 14. It will be appreciated that the construction and components of manually moveable means 40a may be provided in various configurations, materials, sizes, shapes, and arrangements without departing from the scope of the present invention and as would occur to one of ordinary skill in the art. Alternate embodiments of the manual moveable means 40a (not shown) may include a lever type handle that performs the same function as the sleeve. For example; the lever, located on the handle, would be moved up or down to move the brace rod 22 and rake head 44 into the desired position. FIG. 10 illustrates a second embodiment of the manual moveable means 40a; in particular, changes to sleeve 14 from a cylindrical shape to a rectangular shaped sleeve 14b and changes to the handle 12 at the sleeve section of the handle from cylindrical shaped as in 12b to a rectangular shape shown as 12d. In this embodiment, the rectangular shaped sleeve 14b operation and function is the same in many respects as that of sleeve 14 with the only difference being the shape change from cylindrical to rectangular. The inner depth and width of the rectangular shaped sleeve 14b is just slightly larger than the outside dimensions of the rectangular handle 12d so that it can easily and manually slide longitudinally up and down the handle 12d. The rectangular shaped sleeve design provides additional resistance to lateral movement of the brace rod 22 and rake head 44 created from the mating of rectangular wood handle with the rectangular sleeve. This design allows for any unbalanced lateral forces to be transferred to the rake handle at 12d and thereby providing additional resistance to the lateral twisting that can occur during operation of the rake 10 and thereby adds to the overall strength of the rake 10. It will be appreciated that the construction of manually moveable means 40a, and all the components of manually moveable means 40a, may be provided in various configurations, materials, sizes, shapes, and arrangements without departing from the scope of the present invention and as would occur to one of ordinary skill in the art.

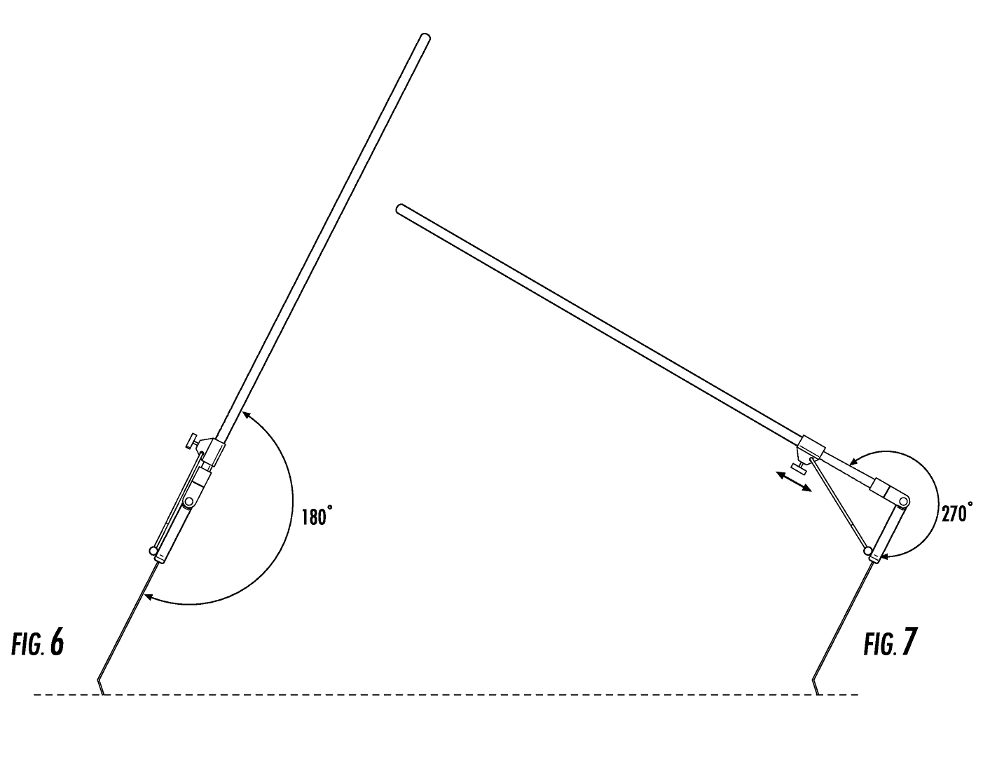

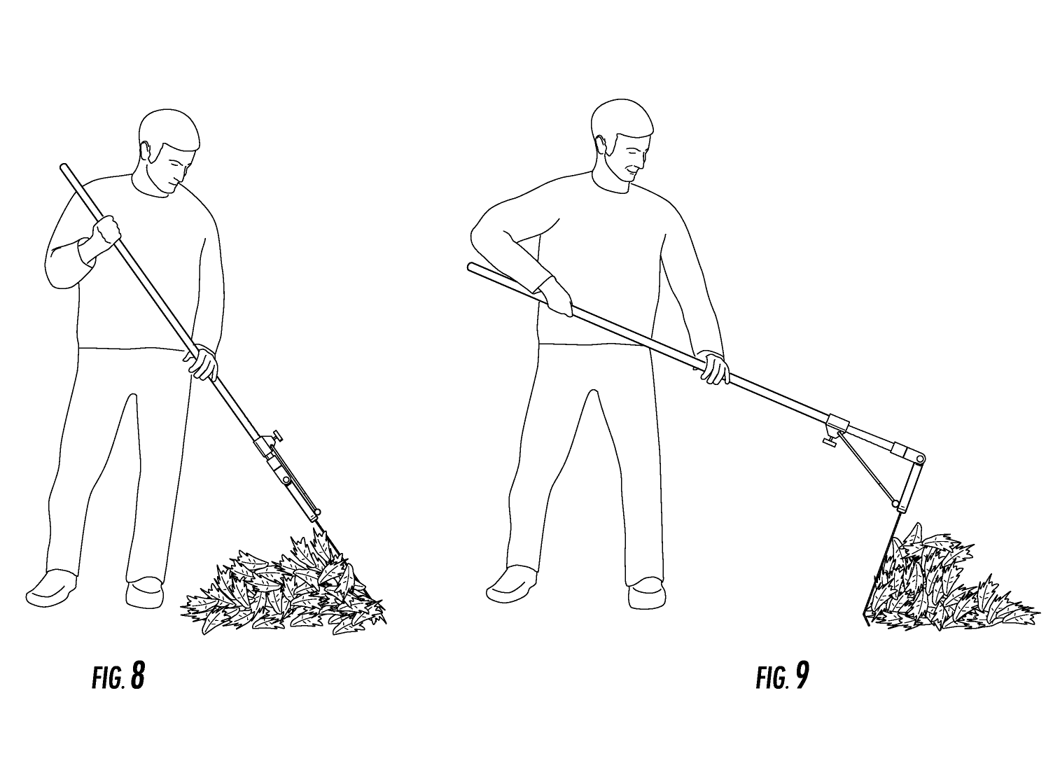

The rake 10 also includes a pivot means 42 which is designed to provide a means for angular displacement between the rake head 44 and the elongated handle 12. Pivot means 42 allows rotation along a pivot axis that is positioned transversely to a longitudinal axis of elongated handle so as to operably provide relative pivoting motion in a direction mainly perpendicular to the rake head first plane and being rotatable from the first position. The preferred embodiment of pivot means 42 is depicted in FIG. 1 and includes an upper pivot collar with socket 24, pivot pin 30, four pivot washers 28, and lower pivot collar 26. The upper pivot collar with socket 24 is forked to afford the lower pivot collar 26. Holes are drilled and aligned so that pivot pin 30 can pass through a first fork of the upper pivot collar 24, the lower pivot collar 26, and then the second fork of the upper pivot collar 24 thus providing the pivot means 42 shown in FIG. 1. The pivot means 42 is configured such that rake head 44 may operably provide relative pivoting motion between rake head 44 and elongated handle. Pivot means 42 is configured such that rake head 44 may rotate from a first position or a straight line of 180 degrees with respect to the elongated handle when using the rake 10 in a conventional or pull mode (first position) of operation to a second position with an angle between 180 degrees and at least 270 degrees for the push or plow mode(s) (second position) of operation. This range of angular displacement of at least 90 degrees between the rake head 44 and elongated handle 12 allows for variations in user heights and individual preferences. FIG. 6 shows rake 10 in a pull mode (first position) when using the rake 10 in a conventional mode of operation. FIG. 7 shows rake 10 in a second position with an angle of about 270 degrees for the push or plow mode(s) (second position) of operation. In certain optional embodiments, pivot means 42 may include a ball bearing and socket pivot system, or a hinge type of pivot, or the like. It will be appreciated that the construction of pivot means 42, and all the components of pivot means 42, may be provided in various configurations, materials, sizes, shapes, and arrangements without departing from the scope of the present invention and as would occur to one of ordinary skill in the art. As yet another example of an embodiment, the pivot means 42 orientation could be reversed such that a lower pivot collar on the rake head 44 is the forked member designed to afford an upper pivot collar with socket.

In the illustrated embodiment, rake 10 employs a locking mechanism 40b as shown in FIG. 1, and in more detail in FIGS. 2 and 3. Locking mechanism 40b is shown attached to the top side of the sleeve 14 and includes locking knob 16, locking pin 20, the compression spring 50, and retainer 52. The locking mechanism 40b allows the manually movable means 40a and the rake head 44 to be securely locked into a plurality of positions ranging from a straight line of 180 degree with respect to the elongated handle to an angle of at least 270 degrees. A plurality of locking ports 18 are located in a longitudinal line and evenly spaced on the top side of handle 12 and are slightly larger in diameter than the locking pin 20 so that the pin 20 can be easily placed into any one of the desired locking ports 18. The locking ports 18 are just deep enough to catch and hold the locking pin 20 in place under the maximum expected loading and not weaken the structural integrity of the rake handle 12. The plurality of locking port 18 destinations allows for individual variations, such as user height or arm length, thereby creating a more comfortable and ergonomic position. Alternate embodiments of the locking device may include additional locking ports so that the rake head angles may vary outside of the 180 to 270 degree range. Other embodiments of the locking mechanism 40b (not shown) may include leaf spring(s), no spring at all, a pressure clamp with lever, or any other device that performs the same function as the locking mechanism 40b. It will be appreciated that the construction of locking mechanism 40b, and all the components of locking mechanism 40b, may be provided in various configurations, materials, sizes, shapes, and arrangements without departing from the scope of the present invention and as would occur to one of ordinary skill in the art.

Generally referring to FIGS. 6, 7, 8 & 9; the operation and use of rake 10 will now be summarized as follows. Starting with the rake head in the first position or pull mode as shown in FIGS. 6 and 8, the operator first pulls locking knob 16 outward in a perpendicular direction in relation to the handle 12 so that the locking pin 20 is extracted from the locking port 18. The operator then moves the manually moveable means 40a (sleeve 14) up the handle 12 toward one of the plurality of locking port 18 destinations. As a result of the upward sleeve movement, the rake head 44 can be positioned to one of the plurality of angular positions from a straight line of 180 degree with respect to the elongated handle 12 to the second position angle somewhere between the straight line of 180 degree and at least 270 degrees. The rake operator must now decide the preferred rake head 44 angle that would be the most comfortable and provide the best position for his/her desired push or plow mode(s) (second position). The operator then releases the knob 16 so that the locking pin 20 can enter the most proximal locking port 18. To operate the rake 10 while in the second position, the rake operator simply turns the rake 10 upside down so that the locking knob 16 is in a downward facing position as shown in FIGS. 7 and 9. The operator can now utilize the rake either of the push or plow mode(s) of operation for the pushing or plowing of leaves.

While the above description contains much specificity, these should not be considered as limiting the scope of the invention, but as merely providing illustrations of some of the presently preferred embodiments of this invention. The following are further examples of some but not all variations and ramifications: Instead of wood, the rake handle can be made of aluminum, fiberglass, plastic, or other materials. Instead of steel, the hinge, locking mechanism, brace rods and supports can be made of plastic, nylon, or other material and in lieu of being separate parts; they can be molded as one unit. For example: the lower pivot collar, support frame, raking tines, lower bracket with bearing socket, and the stiffening cross brace can be molded as one part. All components of the rake 10 will have the necessary strength required to provide a rake that can perform the strength needed to push or plow a pile of wet leaves a significant distance and to pull leaves in the conventional raking mode.

While the present system employs elements which are well known to those skilled in the art of rake design; it combines these elements in a novel way which produces a new result not heretofore discovered. Accordingly, the scope of this invention should be determined, not by the embodiments illustrated but by the appended claims and their legal equivalents.

1. A multifunctional lawn rake that can be converted easily from a pull type rake to a push and plow type rake comprising:
an elongated handle having a longitudinal axis, first and second ends, general uniform cross section across its length;
a rake head having a substantially flat planar structure including a support frame and a plurality of tines which are arranged so as to project from the bottom end of the said support frame and arranged along a first plane with said rake head having a face on one side of said rake head for engaging leaves;
at least two rake head positions including a first position to enable pulling of the rake toward a user and a second position to enable pushing or plowing of the rake away from said user;
at least three modes of operation including pull, push, and plow modes so that during the said pull mode the operator can pull leaves or lawn debris towards the said operator, and when operating the rake in the said push mode, to push said leaves or lawn debris away from said operator and when operating the rake in the said plow mode, to plow said leaves or lawn debris away from said operator;
a pivot means defining a pivot axis that is positioned transversely to a longitudinal axis of said elongated handle so as to operably provide relative pivoting motion in a direction mainly perpendicular to said first plane and being rotatable from said first position;
a manually movable means for selectively operating said rake head between said first and said second positions;
at least one locking mechanism for selectively locking said rake head in one of a plurality of said rake head positions about said pivot axis.

2. The rake in claim 1, wherein said rake head positions include a plurality of positions being located at least throughout 90 degrees of arcuate travel about said pivot axis from said first rake head position wherein an angle of 180 degrees is formed between said elongated handle and said first plane to said second position wherein a second angle between 180 degrees and at least 270 degrees is formed between said elongated handle and said first plane.

3. The rake in claim 1, wherein said rake head positions include a plurality of positions between said first position and said second position to allow for the variations in rake operator height and raking angle preferences.

4. The rake in claim 1, wherein one end of said pivot means is fixedly attached to one end of said rake head and the other end is fixedly attached to the first end of said elongated handle.

5. The rake in claim 1, wherein said pivot means is fixedly attached to said elongated handle.

6. The rake in claim 1, wherein said pivot means is fixedly attached to said rake head support frame.

7. The rake in claim 1, wherein said manually movable means includes a sleeve that is slidable on said handle and is coupled to said rake head for selectively operating said rake head between said first and said second positions.

8. The rake in claim 1, wherein said manually moveable means includes moving the rake head into position by manually manipulating the rake head into the desired position.

9. The rake in claim 1, wherein said manually movable means includes a hand lever on said handle coupled to said rake head for selectively operating said rake head between said first and said second positions.

10. (canceled)

11. (canceled)

12. (canceled)

13. The rake in claim 1, wherein said rake head is any one of or a combination of rectangular, fan, semicircular, or triangular shape.

14. The rake in claim 1, wherein said locking mechanism is located on said pivot means.

15. The rake in claim 1, wherein said locking mechanism is located on said sleeve.

16. The rake in claim 1, wherein said locking mechanism has any one of or a combination of a pin, spring and pin, pressure lever, or the like.

17. (canceled)

18. The rake in claim 1, wherein said elongated handle is fixedly attached at said first end to said rake head.

19. The rake in claim 1, wherein said relative pivoting motion between said rake head and said elongated handle is in a direction mainly perpendicular to said first plane and being rotatable to at least 90 degrees from said first position.

20. The rake in claim 1, wherein said pivot means includes any one of or a combination of a hinge, ball and socket, or the like and where said pivot means permits rotary movement in only one plane.

21. The rake in claim 1 with at least one brace rod member pivotally connected to said rake head and said manually moveable means such that a portion of or all of the force on said rake head can be transmitted to said elongated handle;

22. The rake in claim 21, wherein said brace rod is generally V or U shaped with the apex formed so that the transverse segment can be rotatively retained onto the said manually moveable means and the lower ends rotatively attached to said rake head.

23. The rake in claim 21, wherein said brace rod is a single rod structure, several independent rod type structures, or is a substantially flat planar fan shaped structure.

24. A method for the moving and gathering of lawn debris with a multifunctional rake having a first and second position and three modes of operation (pull, push, and plow) comprising the steps of:
(a) starting in the first position or pull mode; unlocking the locking means;
(b) manually moving the rake head with the manual moveable means which causes the pivot means to rotate from the first position to a second rake head position pivoted with an angle of at least 90 degrees from the first position for the push/plow mode of operation;
(c) locking the rake into the desired push/plow position or second position by manually setting the locking means;
(d) flip the rake over so that the back of the tines are in front of a pile of leaves; and
(e) push the leaves forward with the rake by using arm and body strength or plow the leaves by walking with the rake in a forward motion to the desired destination.
